(19) United States
(12) Patent Application Publication
(10) Pub. No.: US 2010/0219929 A1
(43) Pub. Date: Sep. 2, 2010

(54) THERMAL FUSE WITH CURRENT FUSE FUNCTION

(76) Inventor: Jong-Ho Lee, Daegu (KR)

Correspondence Address: CANTOR COLBURN, LLP, 20 Church Street, 22nd Floor, Hartford, CT, 06103, US

(21) Appl. No.: 12/738,016

(22) PCT Filed: Oct. 14, 2008
(86) PCT No.: PCT/KR2008/006042

§ 371 Date: Apr. 14, 2010

(30) Foreign Application Priority Data
Oct. 15, 2007 (KR) 10-2007-0103353

(51) Int. Cl. H01H 85/02

(52) U.S. Cl. 337/182

(57) ABSTRACT

Disclosed is a thermal fuse structured in such a manner that a resistance heating element which generates heat according to an electric current is mounted within a case charged with a solid fusible material so that the fusible material is liquefied by heat of the resistance heating element caused by the external temperature and also by the current applied to a circuit, accordingly disconnecting the circuit. Since the resistance heating element is integrally formed in the case, the thermal fuse is capable of functioning as both a thermal fuse and a current fuse, disconnecting the circuit by both the external heat and the overcurrent. Especially, when the resistance heating element comprises a positive thermal coefficient (PTC) element capable of temperature measurement, the current flowing through the circuit can be measured.

### TECHNICAL FIELD

The present invention relates to a thermal fuse with a current fuse function, and more particularly to a melting-type thermal fuse structured in such a manner that a general thermal fuse which controls connection and disconnection of a circuit in response to the external temperature is added with a function of a current fuse that prevents overcurrent, by providing a resistance heating element which generates heat according to an electric current within a case charged with a solid fusible material so that the fusible material is melted by heat of the resistance heating element caused by the external temperature or the current applied to the circuit.

### BACKGROUND ART

In general, electronic appliances generating much heat, such as a refrigerator, a plasma display panel (PDP) TV, are equipped with a thermal fuse which disconnects a circuit in accordance with the internal temperature. Therefore, when heat abnormally occurs, a fusible material supporting contact point ends within the thermal fuse is fused, thereby disconnecting the circuit and preventing overheating of the appliance.

Additionally, in order to prevent breakdown of the appliance caused by various factors including inrush current generated upon powering on of an electric circuit of the appliance, increase of the internal temperature, and continuously applied overcurrent, a current fuse for protecting the power circuit is installed to a power input terminal of the electric circuit.

According to the structure disclosed in KR Patent Registration No. 560058, a resistor is dedicatedly connected in serial at the outside of a thermal fuse charged with a fusible material, and a protector is provided wherein the connected thermal fuse and the resistor are received in a dedicated case. According to this, the general thermal fuse which disconnects the circuit by an external heat generated from an appliance can be added with a function of a current fuse which disconnects the circuit by overcurrent.

However, according to the above protector, because the resistor is dedicatedly formed at the outside of the thermal fuse and the serially connected thermal fuse and the resistor are received in the dedicated case, the whole structure is so complicated that the manufacturing cost and other expenses are increased. Furthermore, heat generated from the resistor is hard to be promptly conducted to the fusible material built in the thermal fuse, thereby deteriorating a response time.

In addition, since the protector is not provided with a means to check an operation state of the thermal fuse, it is actually difficult to know temperature of the thermal fuse until the circuit is disconnected.

### DISCLOSURE OF INVENTION

### Technical Problem

Therefore, the present invention has been made in view of the above problems, and it is an object of the present invention to provide a melting-type thermal fuse structured in such a manner that a general thermal fuse which controls connection and disconnection of a circuit in response to the external temperature is added with a function of a current fuse that prevents overcurrent, by providing a resistance heating element which generates heat according to an electric current within a case charged with a solid fusible material so that the fusible material is melted by heat of the resistance heating element caused by the external temperature or the current applied to the circuit.

### Technical Solution

In accordance with an aspect of the present invention, the above and other objects can be accomplished by the provision of a thermal fuse with a function of a current fuse, comprising a case made of a conductive material and connected with a connection terminal, having a receiving space therein, an insulating bush mounted at one side in the receiving space of the case, a fusible material mounted at the other side in the receiving space and fused in case of overheating, a lead terminal mounted to the insulating bush and insulated from the case, and a movable terminal disposed at a space between the insulating bush and the fusible material, being in contact with the case, the movable terminal forming a conducting state between the case and the lead terminal as moving to a certain side and a disconnected state between the case and the lead terminal as moving to the other side. Here, at least one of the movable terminal, the lead terminal, and the case, as a conduction path of the current, comprises a resistance heating element that generates heats upon application of overcurrent, such that the fusible material is fused to separate the lead terminal and the movable terminal, thereby disconnecting a circuit, not only by the external heat but also by heat of the resistance heating element caused by overcurrent.

The thermal fuse may further comprise a first spring mounted between the insulating bush and the movable terminal, and a second spring mounted between the fusible material and the movable terminal, such that, when the fusible material is in a solid state, the first spring is compressed by the second spring, thereby connecting the movable terminal to the lead terminal, and when the fusible material is fused by heat, elastic supporting force of the second spring is lost and therefore the first spring is extended so that the movable terminal is separated from the lead terminal, thereby disconnecting the circuit.

The resistance heating element may comprise a positive thermal coefficient (PTC) element capable of temperature measurement, such that temperature of the thermal fuse can be calculated through measurement of a resistance value of the PTC element.

An end of the movable terminal which contacts the lead terminal is covered with an electrode cap, so that a contacting area between the movable terminal and the lead terminal is increased and accordingly stability of the contact can be improved.

### Advantageous Effects

As can be appreciated from the above description, the thermal fuse according to the embodiment of the present invention is capable of achieving disconnection of a circuit not only by an external heat supplied from an appliance but also by application of overcurrent, which is the function of a current fuse, by including a resistance heating element integrally formed in a case.

Additionally, in accordance with the melting-type thermal fuse according to the embodiment, since a structure such as a movable terminal constituting an existing current conduction path serves as the resistance heating element rather than dedicatedly providing the resistance heating element in the case, the structure can be simplified.

Especially, according to the embodiment of the present invention, a PTC device capable of detection of temperature is applied as the resistance heating element. Therefore, the temperature of the thermal fuse can be detected in real time. Furthermore, by covering an end of the movable terminal with an electrode cap, contact between the movable terminal and a lead terminal can be stabilized.

### BRIEF DESCRIPTION OF THE DRAWINGS

The above and other objects, features and other advantages of the present invention will be more clearly understood from the following detailed description taken in conjunction with the accompanying drawings, in which:

FIG. 1 and FIG. 2 are views showing the whole structure of a melting-type thermal fuse with a current fuse function, according to an embodiment of the present invention; and

FIG. 3 is an operational state view of the melting-type thermal fuse with the current fuse function, illustrating sequential disconnection processes of a circuit caused by an external high temperature or application of overcurrent.

### BEST MODE FOR CARRYING OUT THE INVENTION

Hereinafter, an exemplary embodiment of the present invention will be described in detail with reference to the accompanying drawings.

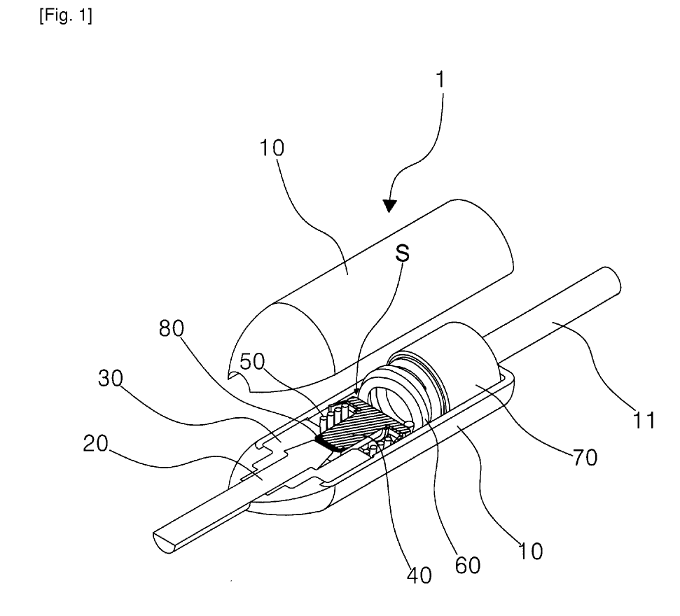

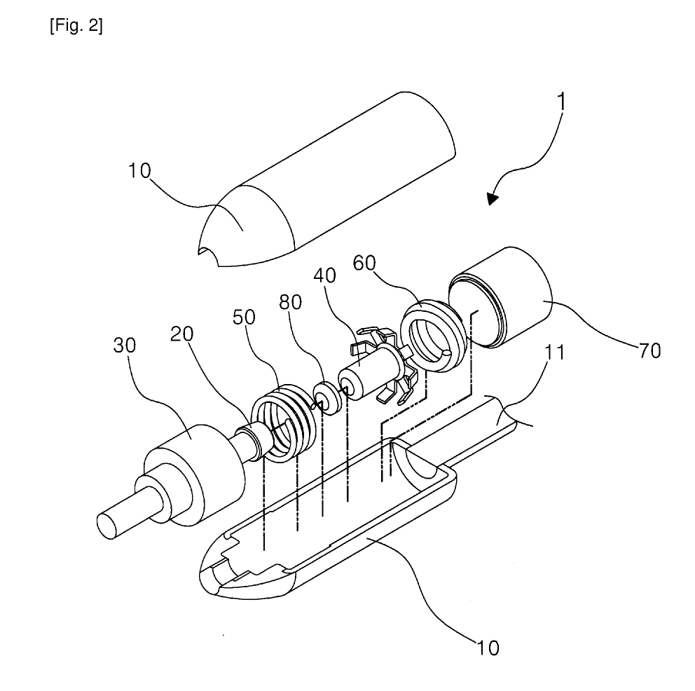

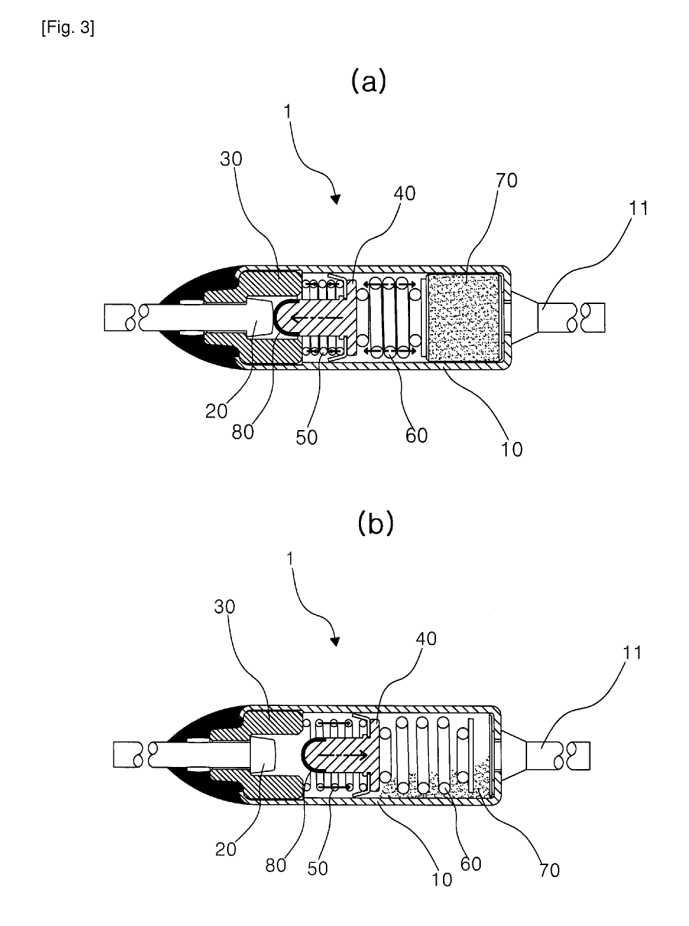

FIG. 1 and FIG. 2 are views showing the whole structure of a thermal fuse with a function of a current fuse, according to the embodiment of the present invention. More specifically, FIG. 1 shows a partially cut state and FIG. 2 shows an assembled state. FIG. 3 shows disconnection processes of a circuit in sequence, caused by an external high temperature or application of overcurrent.

First, the melting-type thermal fuse 1 performs a basic function of a thermal fuse. That is, the thermal fuse 1 protects an appliance from an abnormal heating by being structured and operated in a such manner that a fusible material 70 received in a cylindrical case 10 is fused by an external heat caused by the abnormal heating of the appliance and, according to this, a lead terminal 20 and a movable terminal 40 are distanced from each other, thereby disconnecting a circuit.

More specifically, as shown in FIG. 1 and FIG. 2, the thermal fuse 1 according to the embodiment comprises the case 10 made of a conductive material connected with a connection terminal 11, an insulating bush 30 mounted at one side of a receiving space S inside the case 10, the fusible material 70 mounted at the other side of the receiving space S in the case 10 and fused in case of overheating, the lead terminal 20 mounted to the insulating bush 30 and insulated from the case 10, and the movable terminal 40 disposed at a space between the insulating bush 30 and the fusible material 70, being in contact with the case 10. The movable terminal 40 forms a conducting state between the case 10 and the lead terminal 20 as moving to a certain side and a disconnected state between the case 10 and the lead terminal 20 as moving to the other side.

Additionally, a first spring 50 is mounted between the insulating bush 30 and the movable terminal 40, whereas a second spring 60 is mounted between the fusible material 70 and the movable terminal 40.

Therefore, when the fusible material 70 is in a solid state, the first spring 50 is compressed by the second spring 60 and accordingly the movable terminal 40 is brought into contact with the lead terminal 20. When the fusible material 70 is fused by an external heat upon occurrence of abnormal heating of the appliance, elastic supporting force of the second spring 60 is lost so that the first spring 50 can be extended. Accordingly, the movable terminal 40 is separated from the lead terminal 20, thereby disconnecting the circuit.

An end of the movable terminal 40 is usually in point contact rather than area contact mutually with the lead terminal 20. In case that the lead terminal 20 and the movable terminal 40 coated with a silver coating contact each other for a long time by an elastic supporting force of the second spring 60, an abnormal resistance may be generated at the contacting points between the terminals 20 and 40, thereby causing an unexpected abnormal heating.

To this end, according to the embodiment of the present invention, the end of the movable terminal 40 is covered with an electrode cap 80 having a greater contacting a rea than the end of the movable terminal 40 such that the contacting area between the end of the movable terminal 40 and lead terminal 20 can be increased through the electrode cap 80. As a result, the abnormal heating induced by an unstable contact point between the lead terminal 20 and the movable terminal 40 can be prevented.

Here, the electrode cap 80 may be made of an Ag alloy, for example, comprising Ag, Ag with Cu, or Ag with Cd, so as to have an excellent conductivity.

Thus, as described above, by applying the electrode cap 80 to the movable terminal 40, a more stable operation of the thermal fuse 1 can be guaranteed.

Also, the thermal fuse 1 of this embodiment is structured such that the fusible material 70 is fused not only by the external heat induced by the abnormal heating of the appliance but also by application of overcurrent, thereby separating the lead terminal 20 and the movable terminal 40 from each other. Thus, the thermal fuse can also have the function of the current fuse which is disconnected upon application of overcurrent, in addition to the basic function as the thermal fuse disconnected by the external heat.

For this purpose, in the thermal fuse 1 according to the embodiment of the present invention, any one of the lead terminal 20, the movable terminal 40 and the case 10 comprises a resistance heating element which generates heats upon application of overcurrent.

Such a resistance heating element may refer to any material that promptly generates heat upon the overcurrent, such as Nichrome and a positive thermal coefficient (PTC) element. In this embodiment, the movable terminal 40 comprises the PTC element as the resistance heating element.

When the movable terminal 40 comprises the PTC element that is the resistance heating element, a current temperature of the thermal fuse can be precisely measured in real time through variation of resistance values of the PTC element. Since the technology of measuring the temperature using the resistance value variations of the PTC element is generally known in the art, a detailed description thereof will be omitted herein.

In addition, when the resistance heating element constitutes the movable terminal 40 which is the current conduction path in the melting-type thermal fuse 1, if overcurrent is conducted through the circuit in a state (a) of FIG. 3, the movable terminal 40 comprising the resistance heating element generates heat, accordingly fusing the fusible material 70 by the heat as shown in a state (b). Accordingly, disconnection of the circuit is achieved by the overcurrent, thereby preventing the overcurrent from being applied to the appliance.

As described above, according to the thermal fuse 1 of the embodiment of the present invention, a circuit is disconnected as a fusible material is fused by an external heat caused by an abnormal overheating of an appliance. Also, when overcurrent occurs, the fusible material is fused by heat of a resistance heating element, accordingly disconnecting the circuit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As explained above, a thermal fuse according to the embodiment of the present invention includes a resistance heating element integrally mounted in a case, and therefore is capable of achieving disconnection of a circuit not only by an external heat supplied from an appliance but also by application of overcurrent. That is, the thermal fuse is also equipped with a function of a current fuse. Therefore, when applied to electronic appliances generating much heat such as a refrigerator, a PDP and a TV or other appliances requiring both a thermal fuse and a current fuse to cope with overheating and overcurrent, the thermal fuse can solely achieve effects of the two types of fuses. As a consequence, the cost and the size can be reduced.

1. A thermal fuse with a current fuse function, comprising:
a case made of a conductive material and connected with a connection terminal, having a receiving space therein;
an insulating bush mounted at one side in the receiving space of the case;
a fusible material mounted at the other side in the receiving space and fused in case of overheating;
a lead terminal mounted to the insulating bush and insulated from the case; and
a movable terminal disposed at a space between the insulating bush and the fusible material, being in contact with the case, the movable terminal forming a conducting state between the case and the lead terminal as moving to a certain side and a disconnected state between the case and the lead terminal as moving to the other side,
wherein at least one of the movable terminal, the lead terminal, and the case, as a conduction path of the current, comprises a resistance heating element that generates heats upon application of overcurrent, such that the fusible material is fused to separate the lead terminal and the movable terminal, thereby disconnecting a circuit, not only by the external heat but also by heat of the resistance heating element caused by overcurrent.

2. The thermal fuse according to claim 1, further comprising:
a first spring mounted between the insulating bush and the movable terminal; and
a second spring mounted between the fusible material and the movable terminal,
such that, when the fusible material is in a solid state, the first spring is compressed by the second spring, thereby connecting the movable terminal to the lead terminal, and when the fusible material is fused by heat, elastic supporting force of the second spring is lost and therefore the first spring is extended so that the movable terminal is separated from the lead terminal, thereby disconnecting the circuit.

3. The thermal fuse according to claim 1, wherein the resistance heating element comprises a positive thermal coefficient (PTC) element capable of temperature measurement, such that temperature of the thermal fuse can be calculated through measurement of a resistance value of the PTC element.

4. The thermal fuse according to claim 1, wherein an end of the movable terminal which contacts the lead terminal is covered with an electrode cap, so that a contacting area between the movable terminal and the lead terminal is increased and accordingly stability of the contact can be improved.

5. The thermal fuse according to claim 2, wherein the resistance heating element comprises a positive thermal coefficient (PTC) element capable of temperature measurement, such that temperature of the thermal fuse can be calculated through measurement of a resistance value of the PTC element.

6. The thermal fuse according to claim 2, wherein an end of the movable terminal which contacts the lead terminal is covered with an electrode cap, so that a contacting area between the movable terminal and the lead terminal is increased and accordingly stability of the contact can be improved.
